(19) United States
(12) Patent Application Publication
(10) Pub. No.: US 2024/0308499 A1
(43) Pub. Date: Sep. 19, 2024

(54) VEHICLE BEHAVIOR CONTROL DEVICE AND VEHICLE BEHAVIOR CONTROL METHOD

(71) Applicant: Honda Motor Co., Ltd., Tokyo (JP)

(72) Inventors: Shinya KOBAYASHI, Tokyo (JP); Akira SHIOGAI, Tokyo (JP)

(73) Assignee: Honda Motor Co., Ltd., Tokyo (JP)

(21) Appl. No.: 18/415,695

(22) Filed: Jan. 18, 2024

(30) Foreign Application Priority Data
Mar. 15, 2023 (CN) 202310248269.0

(51) Int. Cl. B60W 30/02; B60W 10/18; B60W 30/12; G06V 20/56

(52) U.S. Cl. CPC B60W 30/025; B60W 10/18; B60W 30/12; G06V 20/588; B60W 2420/403; B60W 2554/60

(57) ABSTRACT

A vehicle behavior control device and a vehicle behavior control method are provided in the disclosure, which includes the following components. A road surface condition detection unit configured to detect whether an uneven structure extending or spreading along a front-rear direction of a vehicle or a left-right direction of the vehicle exists on a front road surface of the vehicle. A ride comfort control unit, configured to perform ride comfort control by adjusting braking/driving force of each of the front and rear wheels of the vehicle. When the uneven structure is detected by the road surface condition detection unit, the ride comfort control is suppressed.

### CROSS-REFERENCE TO RELATED APPLICATION

This application claims the priority benefit of China application serial no. 202310248269.0 filed on Mar. 15, 2023. The entirety of the above-mentioned patent application is hereby incorporated by reference herein and made a part of this specification.

### BACKGROUND

### Technical Field

The disclosure relates to a vehicle behavior control device and a vehicle behavior control method.

### Description of Related Art

In recent years, efforts have been actively made to provide access to sustainable transportation systems for those in vulnerable positions, such as the elderly, the disabled, or children. In order to achieve the above-mentioned purpose, research and development are devoted to further improving the safety and convenience of traffic through developments related to the behavioral stability of vehicles.

In a vehicle control device that variably sets the braking/driving force of each wheel of the vehicle, Patent Literature 1 (Japanese Patent Laid-Open No. 2007-118898) discloses a ride comfort control unit, which adjusts the braking/driving force of the vehicle when passing through road surface drops and the like, in order to reduce the pitch rate of the vehicle.

Typically, for the purpose of alerting drivers or preventing drowsiness, the road surface is equipped with uneven structures (e.g., rumble strips or thin-layer pavement). If this uneven structure is used as a means of controlling ride comfort, the vibration of the vehicle when traveling through the uneven structure would decrease. This contradicts the purpose of the uneven structure (to attract attention or prevent drowsiness).

However, in the behavioral stability of the vehicle, preventing interference between the uneven structure such as a rumble strips and ride comfort control is an issue.

### SUMMARY

In order to solve the above-mentioned issue, this disclosure aims to achieve the purpose of ensuring that the uneven structure such as a rumble strip and the ride comfort control do not interfere with each other. Moreover, it further contributes to the development of sustainable transportation systems.

According to an embodiment of the disclosure, a vehicle behavior control device is provided, which includes the following components. A road surface condition detection unit configured to detect whether an uneven structure extending or spreading along a front-rear direction of a vehicle or a left-right direction of the vehicle exists on a front road surface of the vehicle. A ride comfort control unit, configured to perform ride comfort control by adjusting braking/driving force of each of the front and rear wheels of the vehicle. When the uneven structure is detected by the road surface condition detection unit, the ride comfort control is suppressed.

According to another embodiment of the disclosure, a vehicle behavior control method is provided, which includes the following operation. Whether an uneven structure extending or spreading along a front-rear direction of a vehicle or a left-right direction of the vehicle exists on a front road surface of the vehicle is detected. Ride comfort control is performed by adjusting braking/driving force of each of the front and rear wheels of the vehicle. When the uneven structure is detected by the road surface condition detection unit, the ride comfort control is suppressed.

According to the embodiment of the disclosure, when an uneven structure extending or spreading in the front-rear direction or the left-right direction of the vehicle is detected on the front road surface of the vehicle, the ride comfort control is suppressed. As such, the ride comfort control that is performed when the vehicle travels through an uneven structure on a road surface such that the sound or vibration is reduced, which goes against the intention of providing the uneven structure, is suppressed.

### BRIEF DESCRIPTION OF THE DRAWINGS

FIG. 1 shows a block diagram of a vehicle behavior control device according to an embodiment of the disclosure.

FIG. 2 shows a schematic diagram of a scenario illustrated according to an embodiment of the disclosure.

FIG. 3 shows a schematic diagram of another scenario illustrated according to an embodiment of the disclosure.

FIG. 4 shows a schematic diagram of another scenario illustrated according to an embodiment of the disclosure.

FIG. 5 shows a schematic diagram of another scenario illustrated according to an embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

According to an embodiment of the disclosure, in the vehicle behavior control device, the road surface condition detection unit is configured to detect that there is the uneven structure extending or spreading in the front-rear direction of the vehicle on the front road surface of the vehicle. When the road surface condition detection unit detects the uneven structure extending or spreading in the front-rear direction of the vehicle, and a distance in the left-right direction of the vehicle between the vehicle and the uneven structure extending or spreading along the front-rear direction of the vehicle is less than a predetermined value, the ride comfort control unit suppresses the ride comfort control.

According to an embodiment of the disclosure, in the vehicle behavior control device, the uneven structure is a rumble strip. The vehicle behavior control device further includes a lane departure prevention control unit configured to start lane departure prevention control when the vehicle is traveling on the rumble strip. When the distance between the vehicle and the rumble strip in the left-right direction of the vehicle is equal to or less than the predetermined value, the ride comfort control unit suppresses the ride comfort control, and the ride comfort control is prohibited when the vehicle is traveling on the rumble strip.

According to an embodiment of the disclosure, in the vehicle behavior control device, the road surface condition detection unit is configured to detect that there is the uneven structure extending or spreading in the left-right direction of the vehicle on the front road surface of the vehicle. When the road surface condition detection unit detects the uneven structure extending or spreading in the left-right direction of the vehicle, and a distance in the front-rear direction of the vehicle between the vehicle and the uneven structure extending or spreading along the left-right direction of the vehicle is less than a predetermined value, the ride comfort control unit suppresses the ride comfort control.

According to an embodiment of the disclosure, in the vehicle behavior control device, when the road surface condition detection unit detects that the uneven structure extending or spreading in the left-right direction of the vehicle is continuous in the front-rear direction of the vehicle, the ride comfort control unit suppresses the ride comfort control between sections where the uneven structure is continuous in the front-rear direction of the vehicle.

According to an embodiment of the disclosure, in the vehicle behavior control device, the uneven structure is configured to transmit sound or vibration generated when the vehicle travels through the uneven structure to a driver of the vehicle. When the uneven structure is detected by the road surface condition detection unit, the ride comfort control unit suppresses the ride comfort control.

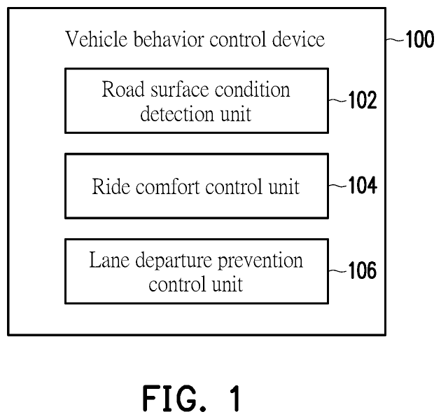

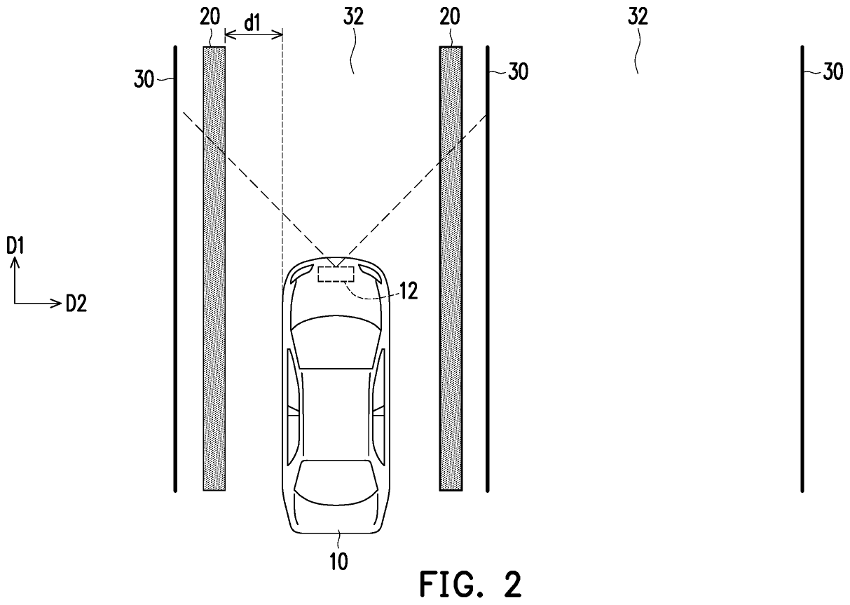

FIG. 1 shows a block diagram of a vehicle behavior control device according to an embodiment of the disclosure. FIG. 2 shows a schematic diagram of a scenario illustrated according to an embodiment of the disclosure. Please refer to both FIG. 1 and FIG. 2 for the following description.

The vehicle behavior control device 100 may at least include a road surface condition detection unit 102 and a ride comfort control unit 104. Here, the ride comfort control unit 104 may also be referred to as a vehicle braking/driving force control device, and is configured to control the braking force and driving force of the vehicle 10. By controlling the vehicle 10 to travel with appropriate braking force and driving force, the driver may be given a comfortable driving experience when the vehicle 10 is traveling on an uneven road surface.

The vehicle behavior control device 100 may be implemented by a computer of the vehicle 10, such as an ECU (electronic control unit) unit of the vehicle. The ECU unit may be implemented, for example, by a processor, and is configured to control various sensors and detectors of the vehicle to receive data, perform various processing on the data, and control various actuating elements of the vehicle 10. Various system controls in the car are controlled by the ECU unit.

The road surface condition detection unit 102 may use various sensors and detectors such as cameras, radars, lidars, etc., to detect the road surface on which the vehicle 10 is traveling and objects on the road surface. According to the embodiment of the disclosure, the road surface condition detection unit 102 is configured to detect whether there is an uneven structure extending or spreading in the front-rear direction D1 of the vehicle 10 or the left-right direction D2 of the vehicle 10 on the front road surface of the vehicle 10.

Using a camera as the road surface condition detection unit 102, the camera may directly photograph the road surface. For example, the camera may directly photograph the uneven structure 20 of the road surface, and then perform image analysis for identification. In addition, the camera may capture warning signs on the road surface, and perform image analysis on the captured warning signs to identify and determine the existence of the uneven structure 20.

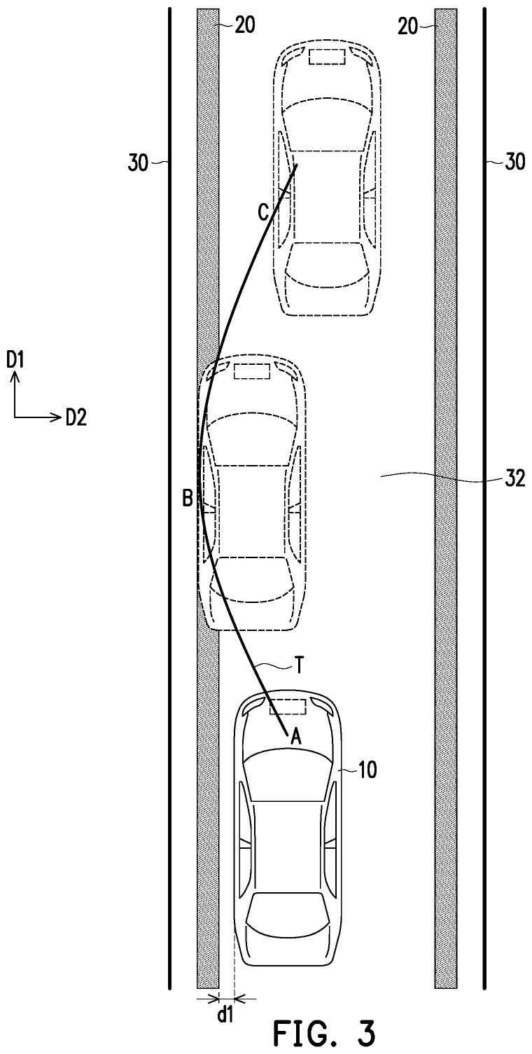

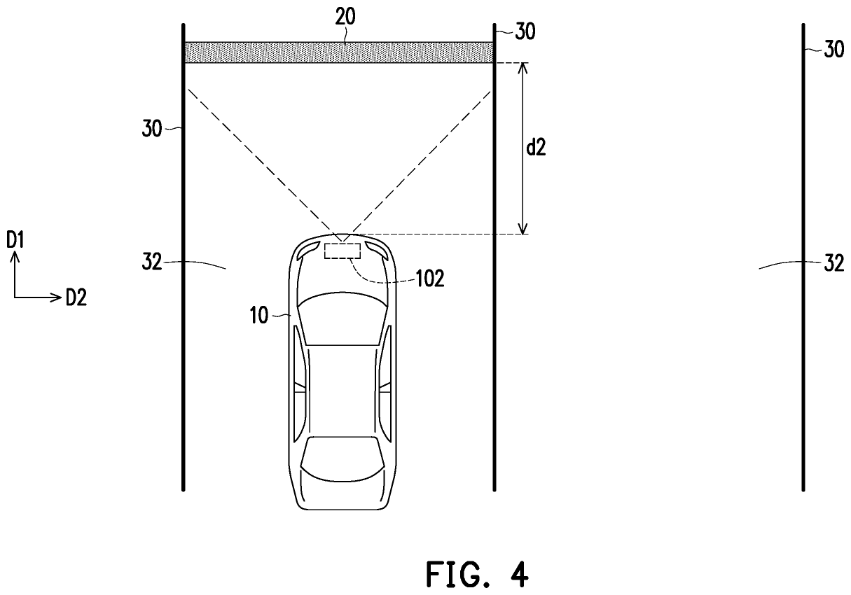

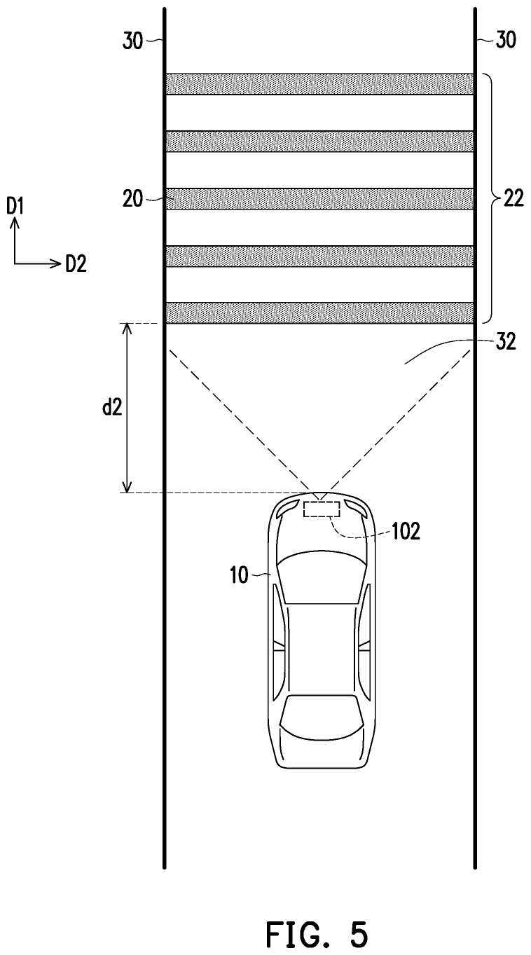

Furthermore, the road surface condition detection unit 102 may use a photographed image of the front road surface of the vehicle 10 to identify the boundary line 30 of the road 32 around the vehicle 10. The boundary line 30 may be, for example, a white marking line, a road shoulder, or the like. Furthermore, on the front road surface of the vehicle 10 in the vehicle lane (road 32) determined based on the combination of the boundary lines 30, the uneven structure 20 extending or spreading in the front-rear direction D1 of the vehicle 10 is detected (examples in FIG. 2 and FIG. 3), or the uneven structure 20 extending or spreading in the left-right direction D2 of the vehicle 10 is detected (examples in FIG. 4 and FIG. 5).

According to the embodiment of the disclosure, the uneven structure 20 extending in the front-rear direction D1 of the vehicle 10 or the left-right direction D2 of the vehicle 10 is, for example, a continuously formed raised structure such as a rumble strip or a speed hump, which may decelerate the vehicle 10. In addition, the uneven structure 20 spreading along the front-rear direction D1 of the vehicle 10 or the left-right direction D2 of the vehicle 10 are, for example, distributed continuously by multiple blocks at intervals. When the vehicle 10 travels through such an uneven structure 20, the vehicle vibrates or makes a sound, thereby reminding the driver of the vehicle to pay attention to the road surface condition.

Here, the uneven structure described in the embodiment of the disclosure may include, for example, a rumble strip, a chatter bar (cats eyes), a melody rumble strip, a thin-layer pavement, and other uneven structures designed to alert drivers and prevent drowsiness. The uneven structure may be configured to attract the attention of the driver of the vehicle and prevent the driver from becoming drowsy.

In addition, the ride comfort control unit 104 is configured to perform ride comfort control by adjusting the braking/driving force of each of the front wheels and rear wheels of the vehicle. When the uneven structure is detected by the road surface condition detection unit 102, the ride comfort control executed by the ride comfort control unit 104 is suppressed or prohibited. By adjusting the braking/driving force of each of the front wheels and rear wheels of the vehicle, the attitude of the vehicle may be adjusted for ride comfort control. Regarding the attitude of the vehicle 10, vehicle attitude control may adjust any roll or yaw behavior in addition to pitch. The ride comfort control unit 104 performs ride comfort control when the vehicle 10 is traveling on the road 32 so as to reduce the vibration of the vehicle to provide ride comfort when encountering uneven road surfaces. However, when the vehicle 10 travels to the uneven structure 20 that is configured to remind the driver to pay attention or prevent the driver from becoming drowsy, the ride comfort control unit 104 suppresses or prohibits the ride comfort control so that the uneven structure 20 may function.

As shown in FIG. 2, the vehicle 10 is traveling on the road 32, and the road 32 may be, for example, a range enclosed by two boundary lines 30. In this embodiment and the embodiments described below, the direction shown by D1 is generally consistent with the length direction of the vehicle, which is the front-rear direction of the vehicle 10, and the direction shown by D2 is generally consistent with the width direction of the vehicle 10, which is the left-right direction of the vehicle 10.

In the embodiment of the disclosure, as shown in FIG. 2, an uneven structure 20 is provided at the boundary line 30 of the road surface close to the road 32. The uneven structure 20 is a structure extending or spreading along the front-rear direction D1 of the vehicle 10. In this example, uneven structures 20 are respectively disposed on the boundary lines 30 on both sides of the road surface close to the road 32. Furthermore, the uneven structure 20 may only be disposed near the boundary line 30 on one side. Furthermore, in the example shown in FIG. 2, the uneven structure 20 is disposed in a straight line extending or spreading along the front-rear direction D1 of the vehicle 10. However, if the road 32 is in the form of a curve (a flat road or a mountain road), the uneven structure 20 extends along the front-rear direction D1 of the vehicle 10 and follows the curve of the road.

Here, as shown in FIG. 2, the road surface condition detection unit 102 is configured to detect whether there is any uneven structure 20 extending or spreading in the front-rear direction D1 of the vehicle 10 on the front road surface of the vehicle 10. When the road surface condition detection section 102 detects the uneven structure 20 extending or spreading in the front-rear direction D1 of the vehicle 10, the ride comfort control section 104 suppresses the ride comfort control. That is, when the road surface condition detection unit 102 detects that the uneven structure 20 exists on the front road surface of the vehicle 10 and the vehicle 10 approaches the uneven structure 20, the ride comfort control unit 104 suppresses the ride comfort control. When the vehicle 10 moves away from the uneven structure 20, the ride comfort control unit 104 resumes execution of ride comfort control.

In this situation, as shown in FIG. 2, when the road surface condition detection unit 102 detects that an uneven structure 20 exists on the front road surface of the vehicle 10, and the traveling path of the vehicle 10 has approached the uneven structure 20, this means that the vehicle 10 may drive onto the uneven structure 20. At this time, in order to allow the uneven structure 20 to achieve its original purpose, that is, to draw the attention of the driver or prevent drowsiness, the ride comfort control unit 104 suppresses the ride comfort control.

Therefore, when an uneven structure extending or spreading in the front-rear direction D1 or the left-right direction D2 of the vehicle 10 is detected on the front road surface of the vehicle 10, the vehicle behavior control device 100 suppresses the ride comfort control executed by the ride comfort control unit 104. As such, the ride comfort control that is performed when the vehicle 10 travels through an uneven structure on a road surface such that the sound or vibration is reduced, which goes against the intention of providing the uneven structure 20, is suppressed.

According to another embodiment of the disclosure, the road surface condition detection unit 102 is configured to detect whether there is any uneven structure 20 extending or spreading in the front-rear direction D1 of the vehicle 10 on the front road surface of the vehicle 10. When the road surface condition detection unit 102 detects that the uneven structure 20 extending or spreading in the front-rear direction D1 of the vehicle 10, and a distance d1 in the left-right direction D2 of the vehicle 10 between the vehicle 10 and the uneven structure 20 extending or spreading along the front-rear direction D1 of the vehicle 10 is less than a predetermined value, the ride comfort control unit 104 suppresses the ride comfort control.

Here, when the uneven structure 20 is disposed along the front-rear direction D1 of the vehicle 10, the distance d1 between the vehicle 10 and the uneven structure 20 is a distance in the left-right direction of the vehicle 10. Furthermore, for the uneven structure 20 on the left side of the vehicle, the distance d1 is calculated, for example, with the left body edge of the vehicle 10 as the baseline. For the uneven structure on the right side of the vehicle 20, the distance d1 is calculated, for example, with the right body edge of the vehicle 10 as the baseline. Furthermore, as a variation example, the distance d1 may be calculated, for example, with the centerline edge of the vehicle 10 as the baseline.

In this situation, as shown in FIG. 2, when the road surface condition detection unit 102 detects that an uneven structure 20 exists on the front road surface of the vehicle 10, the traveling path of the vehicle 10 has approached the uneven structure 20, and the distance d1 (the left-right direction D2 of the vehicle 10) between the vehicle and the uneven structure 20 is already below the predetermined value, this means that the vehicle 10 may drive onto the uneven structure 20. At this time, in order to allow the uneven structure 20 to achieve its original purpose, the ride comfort control unit 104 suppresses the ride comfort control.

In this way, the timing of suppressing the ride comfort control may be controlled more effectively, and the function of suppressing the ride comfort control may not be executed too early. This allows for a balance between the functions of the ride comfort control unit 104 and the uneven structure 20.

Therefore, the ride comfort control starts to be suppressed only when an uneven structure 20 extending or spreading in the front-rear direction D1 of the vehicle 10 is detected on the front road surface of the vehicle 10, and the distance between the vehicle 10 and the uneven structure 20 falls below a predetermined value. Therefore, the ride comfort control unit 104 may perform its function when the vehicle 10 is not close to the uneven structure 20, but the ride comfort control is suppressed only when the vehicle 10 is close to the uneven structure 20. As such, the ride comfort control that is performed when the vehicle 10 travels through an uneven structure 20 on a road surface such that the sound or vibration is reduced, which goes against the intention of providing the uneven structure 20, is suppressed.

According to another embodiment of the disclosure, the vehicle behavior control device 100 as shown in FIG. 1 may further include a lane departure prevention control unit 106. In addition, FIG. 3 shows a schematic diagram of another scenario illustrated according to an embodiment of the disclosure. The scenario shown in FIG. 3 integrates the function of lane departure prevention control.

Moreover, in this embodiment, the uneven structure 20 is a rumble strip, which is a long protruding structure. When the distance from the boundary line 30 in the left-right direction D2 of the vehicle 10 is less than a predetermined value, the uneven structure 20 extending in the front-rear direction D1 of the vehicle 10 may be determined as a rumble strip.

The function of the lane departure prevention control unit 106 is to keep the vehicle 10 on the road 32 serving as a lane when traveling without deviating to an area outside the road, so as to avoid collision with other vehicles, pedestrians or objects. Regarding the lane departure prevention control unit 106, the disclosure does not specifically limit its control method or structure, and any feasible lane departure prevention control may be used. For example, lane departure prevention control may control braking force, driving force, steering angle, rudder angle, or use any other means.

The lane departure prevention control may be performed when the vehicle passes the rumble strip, and the lane departure prevention control may be performed when the vehicle has passed the safe zone for a predetermined period of time.

According to the embodiment of the disclosure, when the vehicle 10 is traveling on the rumble strip (uneven structure 20), the lane departure prevention control unit 106 starts executing the lane departure prevention control. The ride comfort control unit 104 suppresses the ride comfort control when the distance in the left-right direction D2 of the vehicle 10 between the vehicle 10 and the rumble strip (uneven structure 20) is less than a predetermined value. Furthermore, the ride comfort control is prohibited when the vehicle 10 is traveling on a rumble strip (uneven structure 20).

When the vehicle 10 travels on the uneven structure 20, there is a risk that the uneven structure 20 causes the traveling route of the vehicle 10 to deviate from the range of the road 32 (beyond the boundary line 30). Therefore, when the vehicle 10 travels onto the uneven structure 20, the lane departure prevention control unit 106 may operate to perform lane departure prevention control to prevent the vehicle 10 from deviating from the road 32. When the distance d1 in the left-right direction D2 between the vehicle 10 and the rumble strip (uneven structure 20) returns to a predetermined value or more, that is, when the traveling route of the vehicle 10 returns to the range of the road 32, the suppressed ride comfort control unit 104 is activated again to perform ride comfort control.

In addition, in one embodiment, the lane departure prevention control unit 106 may execute lane departure prevention control when the vehicle 10 travels onto a rumble strip (uneven structure 20). Furthermore, when the vehicle 10 travels onto the rumble strip (uneven structure 20) and continues for a predetermined time, the lane departure prevention control unit 106 may execute the lane departure prevention control.

As shown in FIG. 3, it shows a situation in which the vehicle 10 travels along the trajectory T. Initially at position A, the distance d1 in the left-right direction D2 between the vehicle 10 and the uneven structure 20 is lower than a predetermined value, that is, the vehicle 10 is approaching the rumble strip (uneven structure 20). At this time, in order to prevent the rumble strip (uneven structure 20) from losing its proper function, the ride comfort control unit 104 starts to suppress the ride comfort control. In addition, at this time, the vehicle 10 is still traveling within the range of the road 32 and there is no lane departure problem. Therefore, the lane departure prevention control executed by the lane departure prevention control unit 106 may be prohibited.

Next, when the vehicle 10 travels on the rumble strip (uneven structure 20), or continues traveling on the rumble strip (uneven structure 20) for a predetermined time, in other words, the vehicle 10 is at position B of the trajectory, etc., at this time the vehicle 10 has approached the boundary line 30 and the vehicle 10 is traveling on the rumble strip (uneven structure 20). This situation may cause the vehicle 10 to deviate from the range of the road 32 (beyond the boundary line 30). At this time, in order for the rumble strip (uneven structure 20) to function as a reminder to the driver, the ride comfort control unit 104 prohibits the ride comfort control. At the same time, the lane departure prevention control unit 106 also starts to execute lane departure prevention control so that the vehicle 10 may remain within the boundary line 30 and not deviate from the range of the road 32.

Afterwards, when the vehicle 10 leaves the rumble strip (uneven structure 20) and returns to the road 32, the vehicle 10 is at position C of the trajectory. At this time, if the distance d1 in the left-right direction D2 between the vehicle 10 and the rumble strip (uneven structure 20) returns to a predetermined value or more, that is, when the traveling route of the vehicle 10 returns to the range of the road 32, the suppressed ride comfort control unit 104 is activated again to perform ride comfort control. In addition, because the vehicle 10 has returned to the road range 32 at this time and there is no lane departure issue, the lane departure prevention control executed by the lane departure prevention control unit 106 may be prohibited.

According to the present embodiment, when the vehicle 10 approaches a rumble strip (uneven structure 20) or travels onto a rumble strip (uneven structure 20), the vibration of the vehicle 10 becomes smaller. This goes against the intention of providing the uneven structure 20, and is thereby suppressed. Furthermore, when the vehicle 10 approaches the rumble strip (uneven structure 20), the lane departure prevention control unit 106 may provide smooth driving support to prevent the vehicle 10 from deviating from the lane.

FIG. 4 shows a schematic diagram of another scenario illustrated according to an embodiment of the disclosure. In this example, the uneven structure 20 is a structure extending or spreading along the left-right direction D2 on the front road surface of the vehicle 10. The road surface condition detection unit 102 is configured to detect whether there are uneven structures 20 extending or spreading in the left-right direction D2 of the vehicle 10 on the front road surface of the vehicle 10.

At this time, when the road surface condition detection unit 102 detects that the uneven structure 20 extending or spreading in the left-right direction D2 of the vehicle 10, if a distance d2 in the front-rear direction D1 of the vehicle 10 between the vehicle 10 and the uneven structure 20 extending or spreading along the left-right direction D2 of the vehicle 10 is less than a predetermined value, the ride comfort control unit 104 suppresses the ride comfort control. After the rear wheels of the vehicle 10 pass through the uneven structure 20, the ride comfort control unit 104 resumes ride comfort control.

Here, when the uneven structure 20 is disposed along the left-right direction D2 of the vehicle 10, the distance d2 between the vehicle 10 and the uneven structure 20 is a distance in the front-rear direction of the vehicle 10. In this situation, as shown in FIG. 4, when the road surface condition detection unit 102 detects that an uneven structure 20 exists extending or spreading in the left-right direction D2 on the front road surface of the vehicle 10, the traveling path of the vehicle 10 has approached the uneven structure 20, and the distance d2 (the front-rear direction D1 of the vehicle 10) between the vehicle and the uneven structure 20 is already below the predetermined value, this means that the vehicle 10 may drive onto the uneven structure 20. At this time, in order to allow the uneven structure 20 to achieve its original purpose, the ride comfort control unit 104 suppresses the ride comfort control.

In this way, the timing of suppressing the ride comfort control may be controlled more effectively, and the function of suppressing the ride comfort control may not be executed too early. This allows for a balance between the functions of the ride comfort control unit 104 and the uneven structure 20.

Therefore, the ride comfort control starts to be suppressed only when an uneven structure 20 extending or spreading in the left-right direction D2 of the vehicle 10 is detected on the front road surface of the vehicle 10, and the distance between the vehicle 10 and the uneven structure 20 falls below a predetermined value. The ride comfort control unit 104 may perform its function when the vehicle 10 is not close to the uneven structure 20, but the ride comfort control is suppressed only when the vehicle 10 is close to the uneven structure 20. As such, the ride comfort control that is performed when the vehicle 10 travels through an uneven structure 20 on a road surface such that the sound or vibration is reduced, which goes against the intention of providing the uneven structure 20, is suppressed.

FIG. 5 shows a schematic diagram of another scenario illustrated according to an embodiment of the disclosure. In this example, the uneven structure 20 is a structure extending or spreading along the left-right direction D2 on the front road surface of the vehicle 10. Furthermore, multiple uneven structures 20 are arranged (e.g., parallel to each other) in the continuous section 22 in the front-rear direction D1 of the vehicle 10. The road surface condition detection unit 102 is configured to detect whether there are uneven structures 20 and their range extending or spreading in the left-right direction D2 of the vehicle 10 on front road surface of the vehicle 10.

For example, as shown in FIG. 5, when the road surface condition detection unit 102 detects that the uneven structure 20 extending or spreading in the left-right direction D2 of the vehicle 10 is continuously disposed in the continuous section 22 in the front-rear direction D1 of the vehicle 10, the ride comfort control unit 104 suppresses the ride comfort control executed by the ride comfort control unit 104 between the sections (continuous sections) in which the uneven structure 20 is continuous in the front-rear direction of the vehicle 10.

Here, when the road surface condition detection unit 102 detects that the uneven structure 20 extending or spreading in the left-right direction D2 is continuously disposed in a continuous section on the front road surface of the vehicle 10, and the distance d2 in the front-rear direction D1 between the vehicle 10 and the uneven structure 20 (the distance d2 between the vehicle 10 and the one closest to the vehicle 10 among the uneven structures 20) is less than a predetermined value, this indicates that the traveling path of the vehicle 10 has approached the uneven structure 20, which means that the vehicle 10 may drive onto the uneven structure 20. At this time, in order to allow the uneven structure 20 to achieve its original purpose, the ride comfort control unit 104 suppresses the ride comfort control.

An example of such uneven structures 20 disposed in the continuous section 22 is a melody path. As the vehicle 10 travels through each uneven structure 20 serving as a melody path, different sounds are generated to form a melody, thereby attracting the attention of the driver to reduce the vehicle speed or be mindful of the road conditions.

Regarding the continuous section, the road surface condition detection unit 102 may determine based on the intervals between the uneven structures 20 on the road 32, or may use a camera to capture a sign (e.g., the end point of a melody path) for image analysis. After the vehicle leaves the last uneven structure 20 in the continuous section 22, the ride comfort control unit 104 resumes execution of ride comfort control.

According to this embodiment, it may be ensured that in the continuous section 22 with the uneven structure 20 extending or spreading in the left-right direction D2 of the vehicle 10 on the front road surface of the vehicle 10, the effect of reducing sound or vibration when the vehicle 10 travels through the continuous section of the uneven structure 20 due to the ride comfort control may be suppressed.

Furthermore, in one embodiment, the uneven structure 20 may be configured to transmit the sound or vibration generated when the vehicle 10 travels through the uneven structure 20 to the driver of the vehicle 10. When such uneven structure 20 is detected by the road surface condition detection unit 102, the ride comfort control unit 104 suppresses the ride comfort control.

As such, the ride comfort control that is performed when the vehicle 10 travels through an uneven structure 20 on a road surface such that the sound or vibration is reduced, which goes against the intention (to draw attention of the driver or prevent drowsiness) of providing the uneven structure 20, is suppressed. In addition, the embodiment of the disclosure may also prevent interference between the uneven structure 20 provided for the purpose of drawing the attention of the driver or preventing drowsiness and the ride comfort control.

According to the embodiment of the disclosure, when an uneven structure extending or spreading in the front-rear direction or the left-right direction of the vehicle is detected on the front road surface of the vehicle, the ride comfort control is suppressed. As such, the ride comfort control that is performed when the vehicle travels through an uneven structure on a road surface such that the sound or vibration is reduced, which goes against the intention of providing the uneven structure, is suppressed.

Finally, it should be noted that the foregoing embodiments are only used to illustrate the technical solutions of the disclosure, but not to limit the disclosure; although the disclosure has been described in detail with reference to the foregoing embodiments, persons of ordinary skill in 10 the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A vehicle behavior control device, comprising:
a road surface condition detection unit, configured to detect whether an uneven structure extending or spreading along a front-rear direction of a vehicle or a left-right direction of the vehicle exists on a front road surface of the vehicle; and
a ride comfort control unit, configured to perform ride comfort control by adjusting braking/driving force of each of front and rear wheels of the vehicle,
wherein when the uneven structure is detected by the road surface condition detection unit, the ride comfort control is suppressed.

2. The vehicle behavior control device according to claim 1, wherein
the road surface condition detection unit is configured to detect that there is the uneven structure extending or spreading in the front-rear direction of the vehicle of the front road surface of the vehicle,
when the road surface condition detection unit detects the uneven structure extending or spreading in the front-rear direction of the vehicle, and a distance in the left-right direction of the vehicle between the vehicle and the uneven structure extending or spreading along the front-rear direction of the vehicle is less than a predetermined value, the ride comfort control unit suppresses the ride comfort control.

3. The vehicle behavior control device according to claim 2, wherein
the uneven structure is a rumble strip,
the vehicle behavior control device further comprises a lane departure prevention control unit configured to start lane departure prevention control when the vehicle is traveling on the rumble strip,
when a distance between the vehicle and the rumble strip in the left-right direction of the vehicle is equal to or less than the predetermined value, the ride comfort control unit suppresses the ride comfort control, and the ride comfort control is prohibited when the vehicle is traveling on the rumble strip.

4. The vehicle behavior control device according to claim 1, wherein
the road surface condition detection unit is configured to detect that there is the uneven structure extending or spreading in the left-right direction of the vehicle on the front road surface of the vehicle,
when the road surface condition detection unit detects the uneven structure extending or spreading in the left-right direction of the vehicle, and a distance in the front-rear direction of the vehicle between the vehicle and the uneven structure extending or spreading along the left-right direction of the vehicle is less than a predetermined value, the ride comfort control unit suppresses the ride comfort control.

5. The vehicle behavior control device according to claim 1, wherein
when the road surface condition detection unit detects that the uneven structure extending or spreading in the left-right direction of the vehicle is continuous in the front-rear direction of the vehicle,
the ride comfort control unit suppresses the ride comfort control between sections where the uneven structure is continuous in the front-rear direction of the vehicle.

6. The vehicle behavior control device according to claim 1, wherein
the uneven structure is configured to transmit sound or vibration generated when the vehicle travels through the uneven structure to a driver of the vehicle,
when the uneven structure is detected by the road surface condition detection unit, the ride comfort control unit suppresses the ride comfort control.

7. The vehicle behavior control device according to claim 2, wherein
the uneven structure is configured to transmit sound or vibration generated when the vehicle travels through the uneven structure to a driver of the vehicle,
when the uneven structure is detected by the road surface condition detection unit, the ride comfort control unit suppresses the ride comfort control.

8. The vehicle behavior control device according to claim 4, wherein
the uneven structure is configured to transmit sound or vibration generated when the vehicle travels through the uneven structure to a driver of the vehicle,
when the uneven structure is detected by the road surface condition detection unit, the ride comfort control unit suppresses the ride comfort control.

9. The vehicle behavior control device according to claim 5, wherein
the uneven structure is configured to transmit sound or vibration generated when the vehicle travels through the uneven structure to a driver of the vehicle,
when the uneven structure is detected by the road surface condition detection unit, the ride comfort control unit suppresses the ride comfort control.

10. A vehicle behavior control method, comprising:
detecting whether an uneven structure extending or spreading along a front-rear direction of a vehicle or a left-right direction of the vehicle exists on a front road surface of the vehicle
performing ride comfort control by adjusting braking/driving force of each of front and rear wheels of the vehicle;
suppressing the ride comfort control when the uneven structure is detected.
